(19) United States
(12) Patent Application Publication
(10) Pub. No.: US 2026/0074801 A1
(43) Pub. Date: Mar. 12, 2026

(54) PHOTON NUMBER DETERMINATION USING REFRAMED TRACE DATA POINTS

(71) Applicant: XANADU QUANTUM TECHNOLOGIES INC., Toronto (CA)

(72) Inventor: Zeyue NIU, Toronto (CA)

(21) Appl. No.: 19/322,003

(22) Filed: Sep. 8, 2025

Related U.S. Application Data
(60) Provisional application No. 63/693,906, filed on Sep. 12, 2024.

(51) Int. Cl. H04B 10/70; G06N 10/40; G06N 20/00

(52) U.S. Cl. CPC H04B 10/70; G06N 10/40; G06N 20/00

(57) ABSTRACT

Systems, methods, and computer program products for determining a photon number. Electrical signal trace data is received by a signal processor. A plurality of trace data points are defined based on the received electrical signal trace data. Each trace data point includes both a signal value and a time value indicating the position of that trace data point within the electrical signal trace. The trace data points are input to a machine learning model trained to output predicted photon number data usable to determine the photon number corresponding to the received electrical signal trace. The machine learning model can be trained to output predicted photon number data based on an incomplete set of trace data points, and even individual trace data points. This can allow the photon number to be predicted when data is partially missing or lost, and/or before the entire electrical signal trace has been received.

### CROSS-REFERENCE TO RELATED APPLICATION

This application claims the priority of U.S. Provisional Patent Application No. 63/693,906 filed Sep. 12, 2024 the entirety of which is incorporated herein by reference.

### FIELD

This document relates to quantum optics. In particular, this document relates to systems and methods for photon number determination.

### BACKGROUND

In the field of quantum optics, photon detectors are used to detect the number of photons present in a pulse of light radiation. Conventional single photon detectors often lack the ability to perform photon number resolution for multi-photon states. Photon-number resolving (PNR) detectors offer the capability to accurately characterize the number of incident photons in an incident light pulse. When a light pulse is incident on a photon-number resolving detector (PNRD), the PNRD produces a corresponding time-domain electrical signal waveform (an electrical signal trace). The electrical signal trace produced by the PNRD can be analyzed to determine the photon number corresponding to the incident light pulse.

### SUMMARY

The following summary is intended to introduce the reader to various aspects of the detailed description, but not to define or delimit any invention.

Systems, methods, and computer program products are provided for determining a photon number associated with an optical signal. Electrical signal trace data corresponding to the optical signal is received by a signal processor. The electrical signal trace data is typically produced by a photon-number resolving detector in response to an optical pulse from a light source (e.g., a pulsed laser). The signal processor determines the photon number of the optical pulse by inputting trace data points (determined from the electrical signal trace data) into a machine learning model. An output signal can be defined based on the determined photon number.

The signal processor can define a plurality of trace data points based on the received electrical signal trace data. Each trace data point can include both a signal value and a time value indicating the position of that trace data point within the electrical signal trace data. The trace data points can be input to the machine learning model, and the machine learning model can output predicted photon number data usable to determine the photon number corresponding to the received electrical signal trace. The machine learning model can be trained to output predicted photon number data based on an incomplete set of trace data points, and even based on individual trace data points. This can allow the photon number to be predicted when data is partially missing or lost, and/or before the entire electrical signal trace has been received. This can also allow the signal processor to determine a predicted photon number in a flexible manner that can adapt to different incoming trace data streams.

According to some aspects, the present disclosure provides a method comprising: receiving, by a signal processor, electrical signal trace data from a photon-number resolving detector; determining, by the signal processor, a predicted photon number associated with the electrical signal trace data by inputting a plurality of trace data points to a machine learning model trained to output predicted photon number data in response to receiving one or more trace data points as input, wherein the plurality of trace data points are defined based on the received electrical signal trace data, and wherein each trace data point is defined to include a trace signal value and a trace data point time value; and transmitting, by the signal processor, an output signal based on the determined photon number.

The method can include defining, by the signal processor, the plurality of trace data points based on the electrical signal trace data, where the trace data point time value for a given trace data point indicates a position of that given trace data point within a sequence of trace data points defined by the electrical signal trace data.

The predicted photon number can be determined from the predicted photon number data output by the machine learning model based on a set of trace data points corresponding to a subset of the electrical signal trace data.

The set of trace data points can include a first trace data point, a last trace data point, and a plurality of intermediary trace data points, and the set of trace data points can omit at least one trace data point within a sequence of trace data points defined by the electrical signal trace data.

The signal processor can be configured to define the output signal in response to determining that the predicted photon number has an associated prediction confidence level above a predefined confidence threshold.

The machine learning model can be trained to output at least one point-specific predicted photon number value in response to each trace data point; and the predicted photon number can be determined based on a plurality of point-specific predicted photon number values corresponding to the plurality of trace data points.

For at least one trace data point, the at least one point-specific predicted photon number value can include a plurality of photon number prediction sets; each photon number prediction set can correspond to a potential photon number and include an associated photon number probability for that potential photon number; and the predicted photon number can be determined as the potential photon number having the highest aggregate probability value across the plurality of trace data points.

The machine learning model can be defined as an autoregressive model to accommodate overlapping electrical signal trace data corresponding to a sequence of optical pulses received by the photon-number resolving detector.

The method can include receiving a first optical pulse at a photon-number resolving detector and transmitting the electrical signal trace data from the photon-number resolving detector to the signal processor, where the electrical signal trace data is produced by the photon-number resolving detector in response to the first optical pulse.

The output signal can be a control signal that corresponds to the determined photon number; and the control signal can be transmitted, by the signal processor, to a related signal switch, where the control signal is defined to cause the related signal switch to switch to a specified routing path to route a related optical pulse in response to the control signal.

According to some aspects, the present disclosure provides a computer program product comprising a non-transitory computer readable medium having computer executable instructions stored thereon, the instructions for configuring one or more processors to perform a method comprising: receiving electrical signal trace data from a photon-number resolving detector; determining a predicted photon number associated with the electrical signal trace data by inputting a plurality of trace data points to a machine learning model trained to output predicted photon number data in response to receiving one or more trace data points as input, wherein the plurality of trace data points are defined based on the received electrical signal trace data, and wherein each trace data point is defined to include a trace signal value and a trace data point time value; and transmitting an output signal based on the determined photon number.

The method can include defining the plurality of trace data points based on the electrical signal trace data, where the trace data point time value for a given trace data point indicates a position of that given trace data point within a sequence of trace data points defined by the electrical signal trace data.

The predicted photon number can be determined from the predicted photon number data output by the machine learning model based on a set of trace data points corresponding to a subset of the electrical signal trace data.

The set of trace data points can include a first trace data point, a last trace data point, and a plurality of intermediary trace data points, and the set of trace data points can omit at least one trace data point within a sequence of trace data points defined by the electrical signal trace data.

The instructions can be defined to configure the one or more processors to define the output signal in response to determining that the predicted photon number has an associated prediction confidence level above a predefined confidence threshold.

The machine learning model can be trained to output at least one point-specific predicted photon number value in response to each trace data point; and the instructions can be defined to configure the one or more processors to determine the predicted photon number based on a plurality of point-specific predicted photon number values corresponding to the plurality of trace data points.

For at least one trace data point, the at least one point-specific predicted photon number value can include a plurality of photon number prediction sets; each photon number prediction set can correspond to a potential photon number and include an associated photon number probability for that potential photon number; and the instructions can be defined to configure the one or more processors to determine the predicted photon number as the potential photon number having the highest aggregate probability value across the plurality of trace data points.

The machine learning model can be defined as an autoregressive model to accommodate overlapping electrical signal trace data corresponding to a sequence of optical pulses received by the photon-number resolving detector.

The instructions can be defined to configure the one or more processors to: define the output signal as a control signal that corresponds to the determined photon number; and transmit the control signal to a related signal switch, where the control signal is defined to cause the related signal switch to switch to a specified routing path to route a related optical pulse in response to the control signal.

According to some aspects, the present disclosure provides a system comprising: one or more processors; and one or more non-transitory storage mediums having stored thereon a machine learning model trained to output predicted photon number data in response to receiving one or more trace data points as input; wherein the one or more processors are configured to: receive electrical signal trace data from a photon-number resolving detector; determine a predicted photon number associated with the electrical signal trace data by inputting a plurality of trace data points to the machine learning model, wherein the plurality of trace data points are defined based on the received electrical signal trace data, and wherein each trace data point is defined to include a trace signal value and a trace data point time value; and transmit an output signal based on the determined photon number.

The one or more processors can be configured to: define the plurality of trace data points based on the electrical signal trace data, where the trace data point time value for a given trace data point indicates a position of that given trace data point within a sequence of trace data points defined by the electrical signal trace data.

The predicted photon number can be determined from predicted photon number data output by the machine learning model based on a set of trace data points corresponding to a subset of the electrical signal trace data.

The set of trace data points can include a first trace data point, a last trace data point, and a plurality of intermediary trace data points, and the set of trace data points can omit at least one trace data point within a sequence of trace data points defined by the electrical signal trace data.

The one or more processors can be further configured to define the output signal in response to determining that the predicted photon number has an associated prediction confidence level above a predefined confidence threshold.

The machine learning model can be trained to output at least one point-specific predicted photon number value in response to each trace data point; and the one or more processors can be configured to determine the predicted photon number based on a plurality of point-specific predicted photon number values corresponding to the plurality of trace data points.

For at least one trace data point, the at least one point-specific predicted photon number value can include a plurality of photon number prediction sets; each photon number prediction set can correspond to a potential photon number and can include an associated photon number probability for that potential photon number; and the one or more processors can be configured to determine the predicted photon number as the potential photon number having the highest aggregate probability value across the plurality of trace data points.

The machine learning model can be defined as an autoregressive model to accommodate overlapping electrical signal trace data corresponding to a sequence of optical pulses received by the photon-number resolving detector.

The system can include a photon-number resolving detector operable to: receive a first optical pulse; produce the electrical signal trace data in response to the first optical pulse; and transmit the electrical signal trace data to the one or more processors.

The one or more processors can be configured to: define the output signal as a control signal that corresponds to the determined photon number; and transmit the control signal to a related signal switch, where the control signal is defined to cause the related signal switch to switch to a specified routing path to route a related optical pulse in response to the control signal.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example system for photon number determination;

FIG. 2 is a flowchart of an example method for determining a photon number;

FIG. 3 is a flowchart of an example method for determining a photon number using a neural network;

FIG. 4 shows an example plot of simulated electrical signal traces corresponding to incident light pulses with between 0 to 6 photons;

FIG. 5 shows an example plot of photon number classification results generated using principal component analysis for the simulated traces shown in FIG. 4;

FIG. 6 shows an example plot of recall, F1 score, and accuracy for an example neural network trained to classify electrical signal trace data using the entire signal trace and an example neural network trained to classify electrical signal trace data using a set of trace data points; and

FIG. 7 shows an example plot of the relative importance of trace data points on the result of classifying electrical signal trace data using a neural network trained to classify electrical signal trace data using a set of trace data points.

FIG. 8 shows an example plot of electrical signal traces for optical pulses with up to 8 photons identified using a neural network trained to classify electrical signal trace data using a set of trace data points.

FIG. 9 shows an example plot of electrical signal traces for optical pulses with up to 5 photons identified using principal component analysis.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors, or owners do not intend to abandon, disclaim, or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical, or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods, and computer program products for photon number determination. The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g., a pushbutton keyboard, mouse, a touchscreen, and the like), and at least one output device (e.g., a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C for example. Alternatively, or in addition thereto, some of these elements implemented via software may be written in assembly language, machine language, or firmware as needed. In either case, the language may be a compiled or interpreted language.

At least some of these software programs may be stored on a storage medium (e.g., a computer readable medium such as, but not limited to, ROM, magnetic disk, or optical disc) or a device that is readable by a general or special purpose programmable device. The software program code, when read by the programmable device, configures the programmable device to operate in a new, specific, and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Photon-number resolving detectors (PNRDs) have gained considerable attention in recent years within the field of quantum optics. PNRDs can be used to characterize the number of incident photons in an incident light pulse. The ability of PNRDs to discriminate between optical states with different photon numbers makes them suitable for various applications in quantum optics, including for the use of non-Gaussian resources. Non-Gaussian resources, such as states, operations, or measurements, are essential or at least advantageous for many applications, such as quantum computation, quantum error correction, or quantum communication. The ability to discriminate between states with different photon numbers (particularly in real-time) is useful for non-Gaussian quantum state preparation, state characterization (tomography), increasing the probability of generating non-Gaussian quantum states through multiplexing, the deterministic implementation of non-Gaussian operations using non-Gaussian ancilla states, and implementation of the KLM quantum protocol. For example, some photonic quantum computing architectures make use of PNRDs for the production of bosonic qubits.

The present disclosure relates to a system, method, and computer program product for photon number determination. Electrical signal trace data is received by a signal processor. The electrical signal trace data corresponds to an optical pulse received by a photon-number resolving detector. Trace data points (determined from the electrical signal trace data) can be input to a machine learning model that is trained to output predicted photon number data based on the trace data points. The photon number corresponding to the electrical signal trace data can then be determined using the predicted photon number data.

The electrical signal trace data is typically produced by a photon-number resolving detector in response to an optical pulse from a light source (e.g., a pulsed laser). The signal processor can determine the photon number associated with the optical pulse using the trace data points.

A set of trace data points can be defined based on the electrical signal trace data received by the signal processor. Each trace data point can include a signal value (i.e., a value indicating the amplitude of the electrical signal trace at that trace data point) and a time value indicating the position of that trace data point within the electrical signal trace data. Trace data points can be input to the machine learning model individually or as a set, and the machine learning model can provide an output (the predicted photon number data) usable to determine the photon number corresponding to the received electrical signal trace.

The machine learning model can be trained to output the predicted photon number data based on an incomplete set of trace data points. The machine learning model may be trained to output point-specific predicted photon number data for each trace data point individually. This can allow the photon number to be predicted when data is partially missing or lost, and even before the entire electrical signal trace has been received.

The signal processor can define an output signal based on the determined photon number. The output signal can be used, for example, to route an optical signal related to the optical pulse (e.g., to route a related signal through a quantum computing architecture).

For instance, quantum computing applications may require the generation of non-Gaussian states heralded on photon number detection outcomes. That is, a control signal can be defined to flag the existence of a non-Gaussian state, based on photon number detection outcomes, so that the non-Gaussian state can be manipulated and transferred. The control signal can be defined to flag the existence of a particular non-Gaussian state in a related optical signal so that the related optical signal can be correctly routed for subsequent manipulation or measurement. The control signal may identify whether the related optical signal has the correct signal properties (e.g., a desired pattern of photons in specified optical modes) for further processing or whether the related optical signal should be re-routed or even discarded (e.g., when a desired pattern of photons is not present).

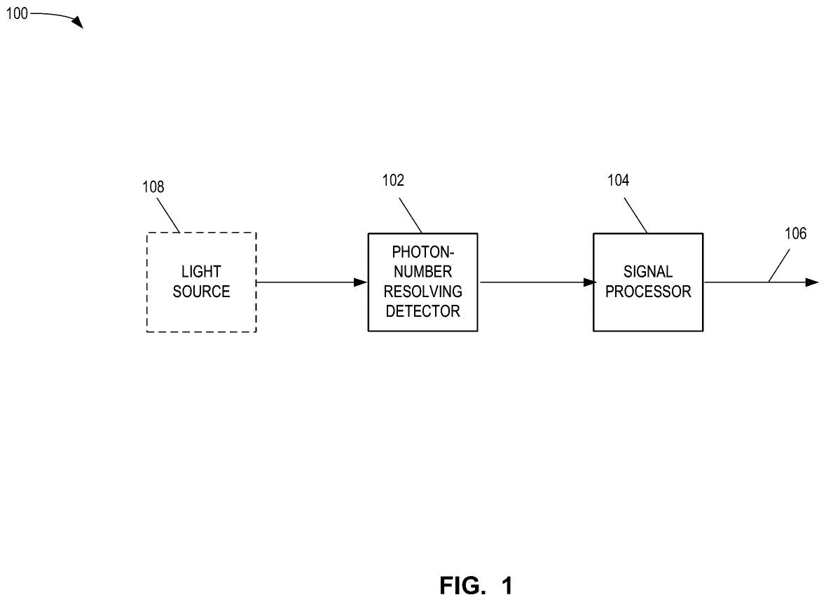

Referring now to FIG. 1, shown therein is a block diagram illustrating an example system 100 that can be used to route optical signals. System 100 can be used to determine the photon number of an incoming light pulse generated by a light source 108, generate an output signal in response to the determined photon number, and use the output signal to control downstream operations within a photonic system (e.g., as a control signal to operate a switch to select the forward routing path for a related optical signal).

As shown in FIG. 1, system 100 includes a photon-number resolving detector 102 and a signal processor 104. System 100 can also include a light source 108 and an output signal path 106, however it should be understood that aspects of the photon number determination methods described herein can be implemented in the absence of the output signal path 106 and the light source 108. Some aspects of the systems and methods described herein may be implemented even in the absence of the photon-number resolving detector 102—i.e., by components of the signal processor 104. Furthermore, although only one light source 108, photon-number resolving detector 102, signal processor 104, and output signal path 106 are shown in the example of FIG. 1, it should be understood that system 100 can include multiple light sources 108, photon-number resolving detectors 102, signal processors 104, and output signal paths 106. System 100 can also include various additional components beyond those shown in the example of FIG. 1.

The photon-number resolving detector 102 is arranged to receive an optical pulse from light source 108. Although shown as a component of system 100, light source 108 may be separate from, and located outside of, system 100 as an independent component or a subcomponent of another system. The light source 108 may, for example, be a pulsed photon source that is capable of generating faint laser pulses, or a resonator capable of generating squeezed light pulses or single-photon generating sources. The light source 108 can include suitable optical components usable to generate the optical pulse. Optionally, the light source 108 can be configured to transmit an optical pulse with a particular optical mode.

In some examples, the system 100 can operate with a plurality of light sources 108, each configured to transmit an optical pulse with a corresponding source-specific optical mode. Each light source 108 may be coupled to a different, corresponding photon-number resolving detector 102 of a plurality of photon-number resolving detectors.

Optionally, the plurality of photon-number resolving detectors 102 may be coupled to a plurality of signal processors 104. For example, each photon-number resolving detector 102 may be coupled to a different signal processor 104. Alternatively, some or all of the photon-number resolving detectors 102 in the plurality of photon-number resolving detectors can be coupled to a single signal processor 102.

The photon-number resolving detector 102 is configured to produce an electrical signal trace in response to an optical pulse from light source 108. The photon-number resolving detector 102 can output the electrical signal trace upon absorption of the incident photons generated by the light source 108. The photon-number resolving detector 102 may be any photon detector that is capable of operating within a linear response region of the detector such as, for example, a transition-edge sensor (TES) based PNR detector, or any other appropriate detector. The detector 102 may be cooled to a superconducting state (i.e., on the order of tens or hundreds of milli-Kelvin) such that it has zero electrical resistance and hence zero voltage drop. The absorption of one or more photons causes a temperature change in the absorber of the detector 102, thereby increasing the resistivity of the detector leading to a voltage drop across the detector. The voltage drop may be proportional to the number of photons absorbed by the PNR detector 102.

The signal processor 104 is electrically coupled to the photon-number resolving detector 102. The signal processor 104 is arranged to receive the electrical signal trace produced by the photon-number resolving detector 102 in response to an optical pulse from the light source 108.

The signal processor 104 can be implemented using one or more processors such as a specialized or general purpose microprocessor. The processor(s) control the operation of the signal processor 104 and in general can include any suitable processor such as a microprocessor, controller, digital signal processor, field-programmable gate array, application-specific integrated circuit, microcontroller, or other suitable computer processor that can provide sufficient processing power, depending on the desired configuration, purposes, and requirements of the system 100.

In some cases, it may be preferable to select a special-purpose processor that is specifically configured for fast operation (e.g., where instructions can be defined in firmware) such as an application-specific integrated circuit or field-programmable gate array for example. This may help reduce the delay between receiving an optical pulse and defining an output signal based on the photon number determined for that optical pulse.

The signal processor 104 can include the processor, a power supply, memory, and a communication module operatively coupled to the processor, the photon-number resolving detector 102, and to the output signal path 106. The memory can include RAM, ROM, one or more hard drives, one or more flash drives, or some other suitable data storage elements such as disk drives, etc. Optionally, the signal processor 104 can include at least one input device (e.g., a pushbutton keyboard, mouse, a touchscreen, and the like) and at least one output device (e.g., a display screen)

The electrical signal trace from the photon-number resolving detector 102 can be detected and recorded using a data acquisition system. The data acquisition system can be integrated into the signal processor 104. Alternatively, the data acquisition system may be external from, and separate to, the signal processor 104.

The data acquisition system can include appropriate hardware circuitry and/or software components usable to detect and record the electrical signal trace from the photon-number resolving detector. Optionally, the data acquisition system can include one or more amplifiers to amplify the output electrical signals (i.e., voltage drop) of the photon-number resolving detector 102. Optionally, the data acquisition system can include an analog-to-digital converter usable to digitize the electrical signal trace such that the electrical signal trace values are quantized into discrete digital quantities.

The non-transitory memory of the signal processor 104 can store machine-readable instructions executable by the one or more processors of the signal processor 104. The instructions stored on the non-transitory memory of the signal processor 104 can be defined to cause the one or more processors to perform processes relating to defining trace data points corresponding to an electrical signal trace, determining a photon number associated with the trace data points, and/or determining an output signal based on one or more photon numbers associated with optical signal pulses.

The signal processor 104 can also store other data in non-transitory memory, such as a machine learning model (e.g., a neural network) trained to output predicted photon number data in response to receiving one or more trace data points as input, desired photon numbers (or desired combinations of photon numbers), confidence thresholds, and other data that may be used in the definition of trace data points, the determination of a photon number associated with an electrical signal trace, and/or an output signal based on one or more photon numbers associated with optical signal pulses.

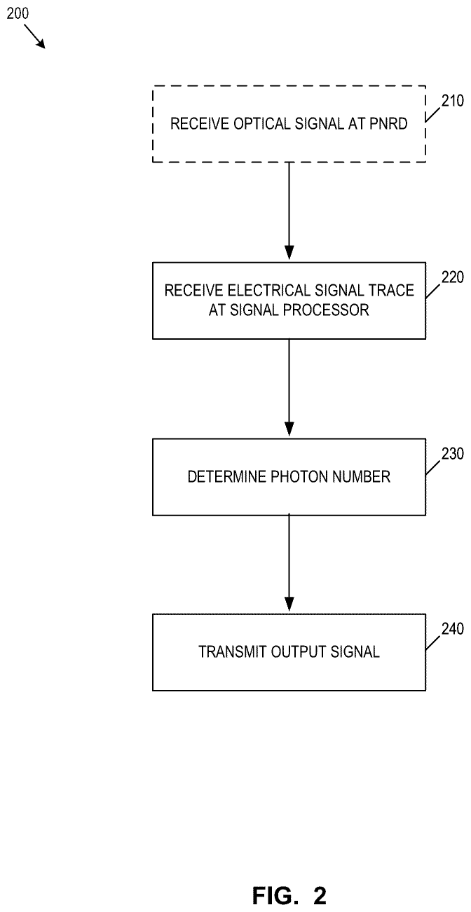

FIG. 2 shows a flowchart of an example process 200 that can be used to transmit an output signal based on a received optical pulse. Process 200 can be implemented by components of a system for determining a photon number, such as the signal processor 104. Process 200 is an example of a process that can determine the photon number of an incoming optical signal and transmit a corresponding output signal based on the determined photon number.

Optionally, at 210 a first optical pulse can be received at a photon-number resolving detector. The optical pulse can be received from a pulsed light source such as a laser. The first optical pulse may be an optical pulse associated with a particular optical mode.

In response to the first optical pulse, the photon-number resolving detector can produce an electrical signal trace. The electrical signal trace can then be transmitted to the signal processor from the photon-number resolving detector.

For example, the photon-number resolving detector can include a transition edge sensor. The photons in the first optical pulse interact with the transition edge sensor of the photon-number resolving detector to produce the electrical signal trace.

Typically, when a pulse arrives at a photon-number resolving detector, such as a transition-edge sensor based photon-number resolving detector, the photon-number resolving detector creates a time-domain voltage waveform (the electrical signal trace) with a characteristic shape that corresponds to the photon number. The waveform includes a rising edge portion, a main body portion and a decaying tail portion. This voltage waveform can be processed to determine the photon number of the optical pulse based on the shape of the waveform. Optionally, the voltage waveform may be digitized and then processed to determine the photon number.

The photon-number resolving detector can receive pulses from the light source at regular intervals. The rate at which the photon-number resolving detector can receive optical pulses may depend on the temporal response of the photon-number resolving detector (e.g., the temporal response of the transition-edge sensor). For example, if a second pulse arrives at the photon-number resolving detector before the characteristic waveform of a first pulse has decayed, an overlap of the waveforms of both pulses can occur resulting in mutual distortion and possibly miscounts. Accordingly, photon-number resolving detectors are often operated with photon pulses well separated (i.e., a second pulse is not received until a first pulse is fully or near fully decayed) in the time domain. This may introduce a limit to the operational speed of the routing system.

In examples described herein, a neural network can be used to determine a predicted photon number for an optical pulse based on a subset of trace data points corresponding to the received optical pulse. The neural network can also be trained to accommodate potentially overlapping electrical signal trace data. These features of the systems and methods described herein can increase the rate at which traces from the photon-number resolving detector can be used to determine the photon number. This may allow a photon-number resolving detector to receive optical pulses more closely together in the time domain while still permitting a photon number to be accurately determined.

At 220, the electrical signal trace produced by a photon-number resolving detector in response to a first optical pulse (e.g., at 210) can be received by a signal processor. The electrical signal trace can be detected and recorded using a data acquisition system separate from, or integrated with, the signal processor.

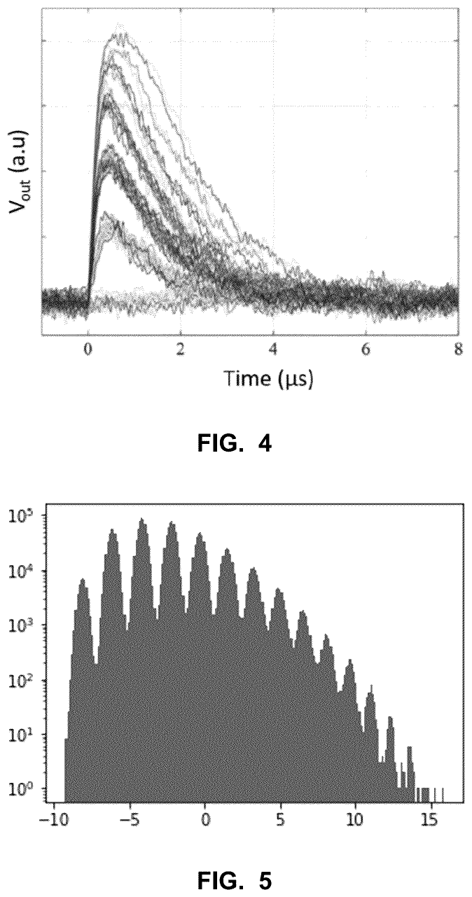

As noted above, a transition edge sensor (TES) having a superconducting material (e.g., tungsten) acting as an absorber operating at or near its critical temperature can be used for PNR detection. When photons are absorbed by the superconducting material, small temperature changes manifest as large changes in resistance. Changes in current through the TES (caused by the absorption of photons) can be read out using a dedicated readout circuit and digitized at a given sampling frequency (e.g., using an analog-to-digital converter). The result is an electrical signal trace whose features depend on the number of photons absorbed. FIG. 4 shows an example plot of simulated TES traces corresponding to incident light pulses having a range of 0 to 6 photons.

At 230, the signal processor can determine a photon number associated with the electrical signal trace data received at 220 (e.g., corresponding to the optical pulse received at 210). The signal processor can input a plurality of trace data points to a machine learning model (e.g., a neural network) trained to output predicted photon number data in response to receiving a trace data point as an input. The trace data points can be defined based on the electrical signal trace data received at 220.

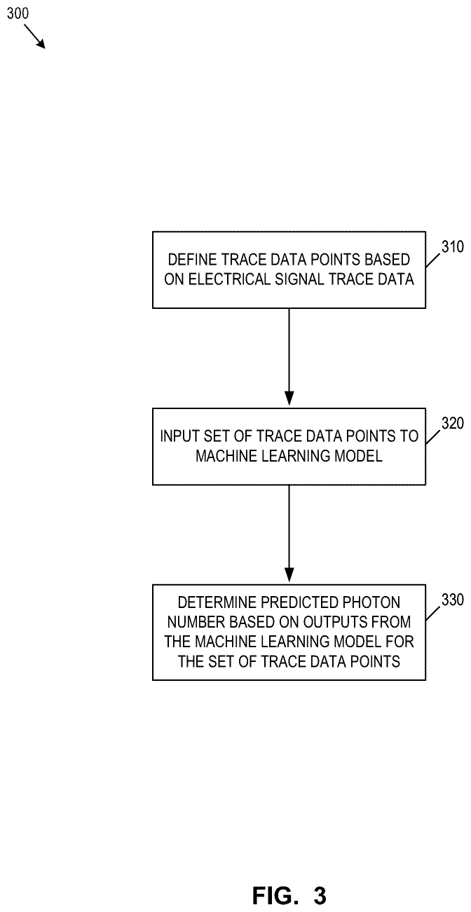

The signal processor can then determine the photon number based on the predicted photon number data from the machine learning model. An example process 300 for determining the photon number using a machine learning model is described in further detail herein below with reference to FIG. 3.

Various methods have been used to classify electrical signal traces with a corresponding photon number. For example, a given TES can be calibrated by detecting a set of test optical signals and analysing the resulting test traces using principal component analysis (PCA). The PCA results from the calibration step can then be used to classify subsequent traces with a corresponding photon number. FIG. 5 shows an example plot of PCA results generated from simulated TES traces.

Existing methods of trace analysis have a number of drawbacks. For example, existing methods do not easily accommodate missing or lost data at one or more arbitrary points along a trace. Typically, trace analysis methods require the entire trace (or at least a consistent length of the trace) for proper analysis. Furthermore, the length of a trace that is needed to discern the photon number to a desired level of confidence may be different from trace to trace.

By contrast, the present disclosure provides a more flexible trace analysis method that can accommodate data loss. The systems and methods described herein may also enable the photon number (corresponding to a electrical signal trace/optical pulse) to be determined from trace data at any point along the trace, including from an incomplete or non-consecutive set of trace data points. This may allow the PNRD clock speed to be significantly improved, as the signal processor may not require the entire trace to be acquired before determining the associated photon number.

At 240, the signal processor can transmit an output signal based on the determined photon number. For example, the signal processor can define a control signal for a downstream or related system component (e.g., a switch). The control signal can be defined based on the photon number determined at 230. The control signal can be transmitted to the related system component, for instance to a related signal switch. The control signal can be defined to cause the related signal switch to switch to a specified routing path to route a related optical pulse in response to the control signal.

The output signal may be determined based on the photon number or number(s) determined for optical pulses received by the photon number determination system. The signal processor can store a look-up table in non-transitory memory to indicate the photon number(s) or combination(s) of photon numbers associated with a given output signal. Accordingly, once the photon number(s) is/are determined at 230, the signal processor can use the look-up table to rapidly determine the output signal to transmit to the related system component.

The method can then return to step 210 and method 200 can be repeated. Method 200 may be repeated on an ongoing basis as a plurality of additional optical pulses are received at the photon-number resolving detector. Steps 220-240 can then be repeated for each of the additional optical pulses. As will be appreciated, method 200 can be performed at regular intervals (e.g., at the intervals when optical pulses are received by the photon-number resolving detector).

Method 200 can also be performed in parallel, e.g., by multiple signal processors receiving electrical signal traces from PNRDs. Optionally, step 240 may be modified such that the output signal is defined based on a combination(s) of photon numbers corresponding to a plurality of electrical signal traces/optical pulses.

Referring now to FIG. 3, shown therein is an example process 300 for determining a photon number associated with an electrical signal trace. The process 300 is an example of a sub-process that may be used at steps 220-230 of method 200. In particular, process 300 provides an example process for determining a photon number by inputting a set of trace data points into a machine learning model. The example process 300 may enable a photon number to be determined using only a subset or portion of the electrical signal trace data received from a photon-number resolving detector. Process 300 can be implemented using various components of a system for photon number determination, such as the signal processor 104.

At 310, a plurality of trace data points can be defined based on the electrical signal trace data (e.g., the trace data received at 220). Each trace data point can be defined to include a trace signal value and a trace data point time value. The trace data point time value for a given trace data point can indicate a position of that given trace data point within the sequence of trace data points defined by the electrical signal trace data. The trace signal value can specify the amplitude of the electrical signal trace at the trace data point position specified by the trace data point time value.

Electrical signal trace data received by the signal processor may be represented as a vector of trace values (v0, v1, . . . , vn), with each trace value representing the trace value at a corresponding trace data point. In the vector of trace values, the location or time of each trace value may be implied by the value's index within the vector.

At 310, the plurality of trace data points can be defined by reframing the data from the PNRD trace to include a time value for the trace value at each trace data point. The time associated with the corresponding trace value at each trace data point can be defined explicitly in the trace data that is provided as an input to the neural network at 320. For example, a first trace data point may be defined as a vector (v1, t1) that includes a first trace value v1 (specifying the amplitude of the electrical signal trace) and a first time value t1 (defining the time/position within the electrical signal trace data) corresponding to the first trace value. A second trace data point may be defined as a vector (v2, t2), an nth trace data point may be defined as a vector (vn, tn) and so forth.

Reframing the trace data points to include both an explicit time value and the corresponding trace value/signal amplitude allows the time of a given trace data point (or the location/position within the trace) to be known even in the absence of other trace data points. The time value can be defined simply based on the time index of the trace data point within the electrical signal trace. Optionally, the time value can be defined using alternative methods, for instance using a tunable index value defined through a positional embedding process.

At 320, the plurality of trace data can be input to a machine learning model, such as a neural network. The machine learning model can be trained to output predicted photon number data in response to receiving one or more trace data points as an input. The predicted photon number data can provide an indication of the likelihood that the set of trace data points correspond to one or more photon numbers.

At 330, the predicted photon number associated with the electrical signal trace data can be determined based on the predicted photon number data output by the machine learning model at 320. For example, the predicted photon number can be determined based on aggregate predicted photon number values determined from the predicted photon number data output by the machine learning model at 320 in response to a set of trace data points.

The specific operation of steps 320 and 330 can be implemented in numerous different ways. In general, however, the machine learning model can receive a set of trace data points (individually or as a set) as input and output predicted photon number data (either for individual trace data points or the set of trace data points). The aggregate predicted photon number data for the set of trace data points can then be used to determine the photon number for the electrical signal trace/corresponding optical pulse.

Optionally, the machine learning model can be trained to receive each trace data point individually as an input (i.e., each trace data point can be input to the machine learning model separately/independently). The machine learning model can be trained to output predicted photon number data in response to each individual trace data point received. That is, the machine learning model can be trained to output at least one photon number prediction set in response to each individual trace data point received.

By defining the trace data points to include both a trace signal value and a trace data point time value (as described above at 310), the machine learning model can be trained to classify individual trace data points based on these values (trace signal value and a trace data point time value) from a single trace data point alone. The machine learning model can then be trained using this “reframed” trace signal data using a training dataset generated from PNRD trace signals.

As an example, the predicted photon number data can include point-specific predicted photon number values for each trace data point. The machine learning model can receive individual trace data points as an input and can be trained to output at least one point-specific predicted photon number value in response to each trace data point. Each point-specific predicted photon number value can specify the likelihood or probability that the input trace data point (received by the machine learning model) indicates that the electrical signal trace data corresponds to a specific photon number.

The point-specific predicted photon number values can be defined in various ways. For example, the machine learning model may be trained to output a single point-specific predicted photon number value in response to each trace data point. The single point-specific predicted photon number value can identify the most likely photon number determined for the electrical signal trace based on that individual trace data point (i.e., based on that specific combination of trace signal value and trace data point time value). The single point-specific predicted photon number value may be output as a top-1 classification value (i.e., the most likely photon number corresponding to the input trace data point). Optionally, the predicted photon number classification may include the top-1 classification value (i.e., the most likely photon number corresponding to the input trace data point) and an associated probability/confidence value (i.e., the likelihood of that photon number being correct as determined by the machine learning model).

Alternatively, the at least one point-specific predicted photon number value for a trace data point can include a plurality of photon number prediction sets. That is, the machine learning model can be trained to output probability values for multiple potential photon numbers in response to each input trace data point. Each photon number prediction set can be defined to correspond to a specific potential photon number in a plurality of potential photon numbers and include an associated photon number probability value for that specific potential photon number. The form of a photon number prediction set can vary (e.g., a single vector with multiple probability values with the index indicating the potential photon number associated with each probability value, multiple vectors with each vector including a probability value and the associated potential photon number, etc.).

The predicted photon number may then be determined using aggregate predicted photon number values that are defined based on the point-specific predicted photon number values output for each trace data point. For example, the predicted photon number can be determined as the potential photon number having the highest aggregate probability value across the plurality of trace data points.

Aggregate predicted photon number values can be determined based on the point-specific predicted photon number values output by the machine learning model at 320. For example, the aggregate predicted photon number values may be determined based on a sum of the point-specific predicted photon number values output for each trace data point. The predicted photon number can then be determined as the photon number corresponding to the greatest aggregate predicted photon number value.

As a simple example, the set of trace data points received by the machine learning model (at 320) may include 100 trace data points and the machine learning model may be trained to output a single point-specific predicted photon number value for each trace data point. The machine learning model may output predicted photon number values for a 2-photon signal for 90 of the trace data points, output predicted photon number values for a 1-photon signal for 8 of the trace data points, and output predicted photon number values for a 3-photon signal for 2 of the trace data points. The aggregated predicted photon number values may then be defined as an aggregate value of 90 for a 2-photon signal, an aggregate value of 8 for a 1-photon signal, and an aggregate value of 2 for a 3-photon signal. The predicted photon number may then be determined as a 2-photon signal.

Alternatively, the machine learning model may output a plurality of point-specific predicted photon number values corresponding to individual trace data points. In this case, the aggregate predicted photon number values may be determined using the plurality of point-specific predicted photon number values corresponding to each individual trace data point. For example, the aggregate predicted photon number values for each photon number may be determined as a sum of the associated photon number probability values contained in the photon number prediction sets (output based on the set of trace data points) corresponding to that photon number.

Alternatively, the machine learning model may be trained to directly output an aggregate predicted photon number value. For example, the machine learning model may output one or more photon number prediction sets as individual trace data points are received. The machine learning model may continue to update the photon number prediction set as each additional trace data point is received. In this manner, the aggregate predicted photon number values may be defined directly based on the updated photon number prediction set.

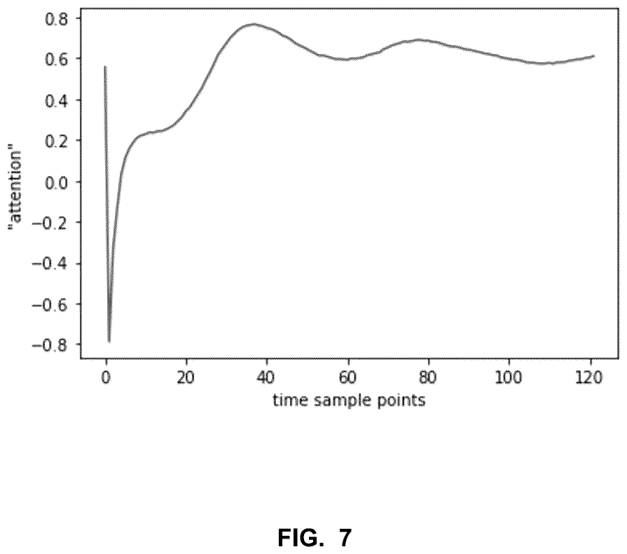

Further alternatively, trace data points from different times/locations in an electrical signal trace may be weighted to reflect how informative they are expected to be about the corresponding photon number. For instance, trace data points corresponding to higher attention locations along an electrical signal trace may be weighted more heavily than trace data points corresponding to lower attention locations along an electrical signal trace. An example attention plot showing the relative importance of different samples along a TES trace on the photon number classification outcome is shown in FIG. 7 and described in further detail herein below.

It will be apparent to those skilled in the art that various alternative methods of defining and determining predicted photon number data, aggregate predicted photon number values, and a predicted photon number may be used without departing from the substance of the methods described herein. For example, alternative methodologies may be used to determine the aggregate predicted photon number values and/or the photon number based on the aggregate prediction data, such as incorporating weightings for the minority predicted photon numbers (like the 1-photon and 3-photon predictions given in the example above), training a second aggregator machine learning model, determining the aggregate predicted photon number values using an average of the point-specific predicted photon number values (e.g., a rolling average or weighted average), etc.

By reframing the trace data to include a trace data point time value, the machine learning model may be capable of receiving the trace data points as a trace data stream. The machine learning model can receive one trace data point from the trace data stream at a given time and output the corresponding at least one point-specific predicted photon number value for that trace data point.

The predicted photon number can then be determined from predicted photon number data output by the machine learning model based on a set of trace data points corresponding to a subset of the electrical signal trace data. For example, the set of trace data points (used to determine the predicted photon number) may include a first trace data point, a last trace data point, and a plurality of intermediary trace data points while omitting at least one trace data point within a sequence of trace data points defined by the electrical signal trace data.

A machine learning model trained to output predicted photon number data based on individual trace data points (or based on a set of trace data points) may provide a more flexible photon number classification system. For instance, the photon number determination system may be capable of classifying electrical signal trace data (i.e., determining a predicted photon number) even where some of the trace data may be missing and/or using trace data points from any point in time along the trace (potentially at different points from trace to trace). This may allow the PNRD clock speed to be increased, as the signal processor may be capable of determining the photon number associated with an electrical signal data even before the entire trace has been acquired.

The use of a neural network as the machine learning model can also provide for a simple and flexible implementation on an FPGA.

In general, the machine learning model can receive (at 320) an individual trace data point at a given time and determine a corresponding predicted photon number value or values. As additional trace data points are received, an aggregate of the outputs from the machine learning model can be updated continually (either by the machine learning model directly or through subsequent processing). The predicted photon number can then be determined based on the aggregated outputs.

Optionally, the predicted photon number may be determined (or at least used to generate an output signal, e.g., at 240) in response to determining that the predicted photon number has an associated prediction confidence level above a predefined confidence threshold. The confidence level associated with the prediction may also be defined in various ways, e.g., as a direct output from the machine learning model, as the aggregated predicted photon number value (e.g., 90% confidence of a 2-photon event in the simple example discussed above), as an output from a second aggregator model, etc. The confidence level may also be defined to be at least partially dependent on the number of trace data points analyzed (e.g., applying a confidence discount rate that decreases as more trace data points, or more trace data points expected to be highly predictive, are received).

Optionally, the neural network can be made autoregressive. The machine learning model can be defined as an autoregressive model to accommodate overlapping electrical signal trace data corresponding to a sequence of optical pulses received by the photon-number resolving detector. This enables the machine learning model to modify its outputs based on previous trace data points and the corresponding predicted photon number data for those previous trace data points. This may be particularly useful for applications that require fast clock cycles where, after a given photon detection event, the PNRD may not fully return to equilibrium before the next photon detection event occurs.

Autoregression could be implemented by defining the machine learning model to include a hidden state that is able to “memorize” historical information. The machine learning model could then use data from the previous photon number classification outputs in order to make a “correction” to the current classification.

### Experimental Results

The inventors tested the use of a neural network model for classifying electrical signal trace data. Simulated traces from TES detectors were generated with associated true photon number labels and used to populate a training dataset of 100,000 traces and a validation dataset of 20,000 traces. A third dataset of 100,000 simulated traces was also generated and analyzed using the PCA method.

The neural network model tested had a single hidden layer, 200 neurons, and a rectified linear unit (ReLU) activation function. The neural network model was trained using the training dataset and then evaluated using the validation dataset. Each of the neural networks tested by the inventors were trained and validated using simulated traces with a 1 MHz pulse frequency (i.e., simulating a TES receiving optical pulses at a rate of 1 MHz).

The confusion matrix for the PCA method is shown in Table 1, while the confusion matrix for the neural network model is shown in Table 2. Table 1 shows a fidelity of 0.98785 while Table 2 shows a fidelity of 0.99966 and a validation accuracy of 0.99945.

TABLE 1
Results of TES trace classification using principal component analysis

| Ground | candidate | | | | | | | | |
|---|---|---|---|---|---|---|---|---|---|
| truth | 0 | 1 | 2 | 3 | 4 | 5 | 6 | 7 | All |
| 0 | 10751 | 9 | 0 | 0 | 0 | 0 | 0 | 0 | 10760 |
| 1 | 4 | 23763 | 20 | 0 | 0 | 0 | 0 | 0 | 23787 |
| 2 | 0 | 8 | 26663 | 42 | 0 | 0 | 0 | 0 | 26713 |
| 3 | 0 | 0 | 19 | 19717 | 77 | 0 | 0 | 0 | 19813 |
| 4 | 0 | 0 | 0 | 36 | 10982 | 120 | 0 | 0 | 11138 |
| 5 | 0 | 0 | 0 | 0 | 76 | 4860 | 84 | 0 | 5020 |
| 6 | 0 | 0 | 0 | 0 | 0 | 122 | 1466 | 362 | 1950 |
| 7 | 0 | 0 | 0 | 0 | 0 | 0 | 22 | 583 | 605 |
| 8 | 0 | 0 | 0 | 0 | 0 | 0 | 0 | 162 | 162 |
| 9 | 0 | 0 | 0 | 0 | 0 | 0 | 0 | 41 | 41 |
| 10 | 0 | 0 | 0 | 0 | 0 | 0 | 0 | 9 | 9 |
| 11 | 0 | 0 | 0 | 0 | 0 | 0 | 0 | 2 | 2 |
| All | 10755 | 23780 | 26702 | 19795 | 11135 | 5102 | 1572 | 1159 | 100000 |

TABLE 2
Results of TES trace classification using a neural network

| Ground | candidate | | | | | | | | | | | | |
|---|---|---|---|---|---|---|---|---|---|---|---|---|---|
| truth | 0 | 1 | 2 | 3 | 4 | 5 | 6 | 7 | 8 | 9 | 10 | 11 | All |
| 0 | 10756 | 0 | 0 | 0 | 0 | 0 | 0 | 0 | 0 | 0 | 0 | 0 | 10756 |
| 1 | 0 | 23808 | 10 | 0 | 0 | 0 | 0 | 0 | 0 | 0 | 0 | 0 | 23818 |
| 2 | 0 | 5 | 26737 | 0 | 0 | 0 | 0 | 0 | 0 | 0 | 0 | 0 | 26742 |
| 3 | 0 | 0 | 1 | 19853 | 0 | 0 | 0 | 0 | 0 | 0 | 0 | 0 | 19854 |
| 4 | 0 | 0 | 0 | 0 | 11137 | 1 | 0 | 0 | 0 | 0 | 0 | 0 | 11138 |
| 5 | 0 | 0 | 0 | 0 | 0 | 5003 | 1 | 0 | 0 | 0 | 0 | 0 | 5004 |
| 6 | 0 | 0 | 0 | 0 | 0 | 3 | 1868 | 2 | 0 | 0 | 0 | 0 | 1873 |
| 7 | 0 | 0 | 0 | 0 | 0 | 0 | 4 | 589 | 5 | 0 | 0 | 0 | 598 |
| 8 | 0 | 0 | 0 | 0 | 0 | 0 | 0 | 1 | 173 | 0 | 0 | 0 | 174 |
| 9 | 0 | 0 | 0 | 0 | 0 | 0 | 0 | 0 | 0 | 33 | 1 | 0 | 34 |
| 10 | 0 | 0 | 0 | 0 | 0 | 0 | 0 | 0 | 0 | 0 | 6 | 0 | 6 |
| 11 | 0 | 0 | 0 | 0 | 0 | 0 | 0 | 0 | 0 | 0 | 0 | 3 | 3 |
| All | 10756 | 23813 | 26748 | 19853 | 11137 | 5007 | 1873 | 592 | 178 | 33 | 7 | 3 | 100000 |

As can be seen from Tables 1 and 2, the neural network model showed greater accuracy than the PCA method (99.945% accuracy vs. 98.875% accuracy) in classifying the simulated traces.

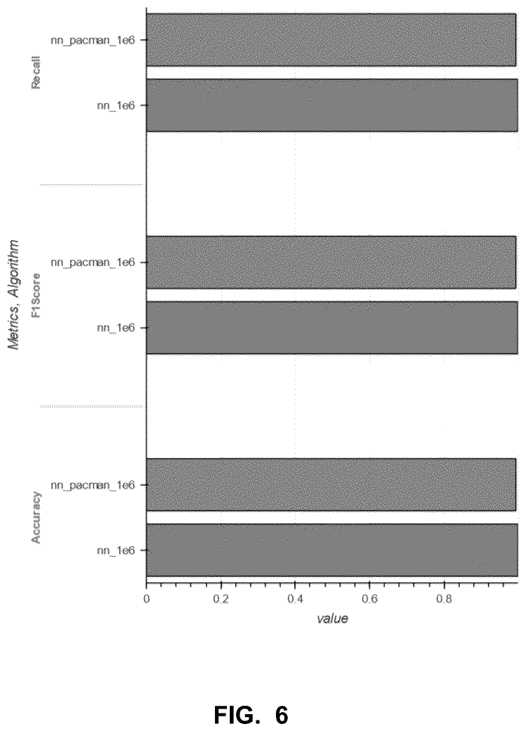

FIG. 6 shows a comparison of a neural network (nn_1e6) trained to classify electrical signal trace data using an entire electrical signal trace and a neural network (nn_pacman_1e6) trained to classify electrical signal trace data using individual trace signal data points. FIG. 6 shows three metrics for each neural network, namely recall, F1 score, and accuracy. As can be seen from FIG. 6, the neural network (nn_pacman_1e6) trained to classify electrical signal trace data using individual trace signal data points achieves the same level of performance as a neural network (nn_1e6) trained to classify electrical signal trace data using an entire electrical signal trace.

Table 3 shows a confusion matrix for the neural network (nn_pacman_1e6) trained to classify electrical signal trace data using individual trace signal data points.

TABLE 3
Confusion matrix for the streamable neural network

| | | | | | | | | | | | | | |
|---|---|---|---|---|---|---|---|---|---|---|---|---|---|
| True | 0 | 3968 | 230 | 0 | 0 | 0 | 0 | 0 | 0 | 0 | 0 | 0 | 0 |
| Label | 1 | 0 | 4160 | 9 | 0 | 0 | 0 | 0 | 0 | 0 | 0 | 0 | 0 |
| | 2 | 0 | 0 | 4243 | 0 | 0 | 0 | 0 | 0 | 0 | 0 | 0 | 0 |
| | 3 | 0 | 0 | 0 | 4218 | 0 | 0 | 0 | 0 | 0 | 0 | 0 | 0 |
| | 4 | 0 | 0 | 0 | 0 | 4080 | 0 | 0 | 0 | 0 | 0 | 0 | 0 |
| | 5 | 0 | 0 | 0 | 0 | 0 | 4058 | 0 | 0 | 0 | 0 | 0 | 0 |
| | 6 | 0 | 0 | 0 | 0 | 0 | 0 | 4071 | 0 | 0 | 0 | 0 | 0 |
| | 7 | 0 | 0 | 0 | 0 | 0 | 0 | 0 | 4175 | 0 | 0 | 0 | 0 |
| | 8 | 0 | 0 | 0 | 0 | 0 | 0 | 0 | 0 | 4232 | 0 | 0 | 0 |
| | 9 | 0 | 0 | 0 | 0 | 0 | 0 | 0 | 0 | 1 | 4159 | 0 | 0 |
| | 10 | 0 | 0 | 0 | 0 | 0 | 0 | 0 | 0 | 0 | 6 | 4160 | 0 |
| | 11 | 0 | 0 | 0 | 0 | 0 | 0 | 0 | 0 | 0 | 0 | 84 | 4146 |
| | | 0 | 1 | 2 | 3 | 4 | 5 | 6 | 7 | 8 | 9 | 10 | 11 |

Predicted Label

The inventors also tested a neural network model trained to classify electrical signal trace data using individual trace signal data points using experimental traces obtained from TES detectors. Table 4 shows a confusion matrix for the neural network trained to classify electrical signal trace data using individual trace signal data points tested using experimental trace data.

TABLE 4
Confusion matrix for the streamable neural
network using experimental trace

| | | | | | | | | | | |
|---|---|---|---|---|---|---|---|---|---|---|
| True | 0 | 1 | 0 | 0 | 0 | 0 | 0 | 0 | 0 | 0 |
| Label | 1 | 0.02 | 0.98 | 0 | 0 | 0 | 0 | 0 | 0 | 0 |
| | 2 | 0 | 0 | 1 | 0 | 0 | 0 | 0 | 0 | 0 |
| | 3 | 0 | 0 | 0 | 1 | 0 | 0 | 0 | 0 | 0 |
| | 4 | 0 | 0 | 0 | 0 | 1 | 0 | 0 | 0 | 0 |
| | 5 | 0 | 0 | 0 | 0 | 0 | 1 | 0 | 0 | 0 |
| | 6 | 0 | 0 | 0 | 0 | 0 | 0.08 | 0.83 | 0.09 | 0.01 |
| | 7 | 0 | 0 | 0 | 0 | 0 | 0 | 0 | 0 | 0 |
| | 8 | 0 | 0 | 0 | 0 | 0 | 0 | 0 | 0 | 0 |
| | | 0 | 1 | 2 | 3 | 4 | 5 | 6 | 7 | 8 |

Predicted Label

The inventors also tested the relative importance of trace data points at different locations along an electrical signal trace on the photon number classification outcome. FIG. 7 shows an attention plot illustrating the relative importance of different trace signal samples along a TES trace. As can be seen from FIG. 7, the relative importance of trace data points varies for different portions of the electrical signal trace.

The inventors further tested the accuracy of a neural network model trained to classify electrical signal trace data using training data with photon numbers up to a maximum of 5 photons in predicting photon number values greater than 5. That is, the inventors tested the accuracy of the neural network model when applied to photon numbers that were outside of the training dataset (also referred to as unseen photon numbers). The inventors identified that the trained neural network model was effective in extrapolating to larger photon numbers, allowing for wider application as compared to a traditional PCA approach.

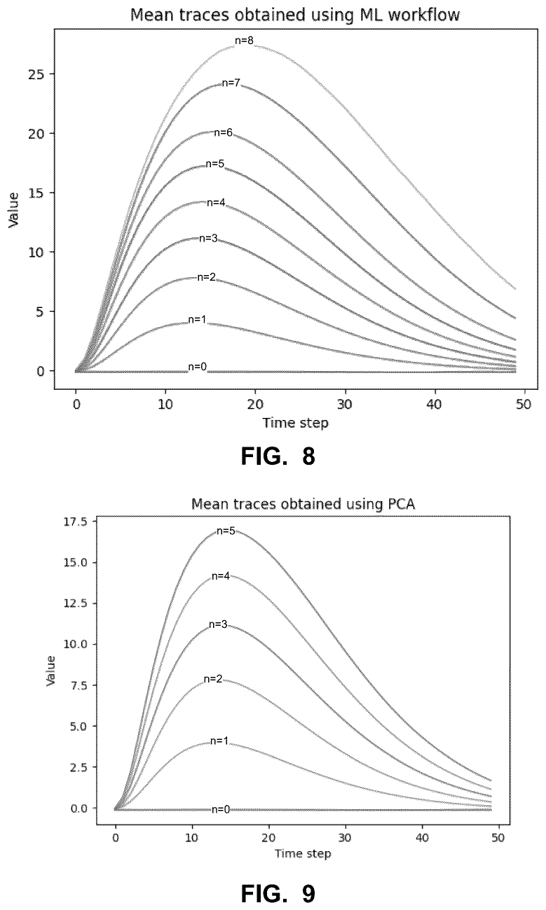

FIG. 8 illustrates example plots of mean electrical signal traces for which the photon number was accurately identified using neural network model trained to classify electrical signal trace data using training data with photon numbers up to a maximum of 5 photons. As can be seen from FIG. 8, signal traces for optical pulses with up to 8 photons were accurately identified by the neural network model, illustrating the ability to extrapolate the photon number determination beyond the photon numbers included in the training dataset.

By contrast, FIG. 9 illustrates example plots of mean electrical signal traces for which the photon number was accurately identified using PCA based on knowledge of electrical signal traces for optical pulses with up to 5 photons. As can be seen from FIG. 9, PCA was only able to accurately identify the photon number for signal traces corresponding to optical pulses with up to 5 photons.

While the above description provides examples of one or more processes or apparatuses or systems, it will be appreciated that other processes or apparatuses or systems may be within the scope of the accompanying claims.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, and/or other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method comprising:
receiving, by a signal processor, electrical signal trace data from a photon-number resolving detector;
determining, by the signal processor, a predicted photon number associated with the electrical signal trace data by inputting a plurality of trace data points to a machine learning model trained to output predicted photon number data in response to receiving one or more trace data points as input, wherein the plurality of trace data points are defined based on the received electrical signal trace data, and wherein each trace data point is defined to include a trace signal value and a trace data point time value; and
transmitting, by the signal processor, an output signal based on the determined photon number.

2. The method of claim 1, wherein the signal processor is configured to define the output signal in response to determining that the predicted photon number has an associated prediction confidence level above a predefined confidence threshold.

3. The method of claim 1, wherein:
the machine learning model is trained to output at least one point-specific predicted photon number value in response to each trace data point; and
the predicted photon number is determined based on a plurality of point-specific predicted photon number values corresponding to the plurality of trace data points.

4. The method of claim 3, wherein:
for at least one trace data point, the at least one point-specific predicted photon number value includes a plurality of photon number prediction sets;
each photon number prediction set corresponds to a potential photon number and includes an associated photon number probability for that potential photon number; and
the predicted photon number is determined as the potential photon number having the highest aggregate probability value across the plurality of trace data points.

5. The method of claim 1, wherein the machine learning model is defined as an autoregressive model to accommodate overlapping electrical signal trace data corresponding to a sequence of optical pulses received by the photon-number resolving detector.

6. The method of claim 1, further comprising receiving a first optical pulse at a photon-number resolving detector and transmitting the electrical signal trace data from the photon-number resolving detector to the signal processor, wherein the electrical signal trace data is produced by the photon-number resolving detector in response to the first optical pulse.

7. The method of claim 1, wherein:
the output signal is a control signal that corresponds to the determined photon number; and
the control signal is transmitted, by the signal processor, to a related signal switch, wherein the control signal is defined to cause the related signal switch to switch to a specified routing path to route a related optical pulse in response to the control signal.

8. A computer program product comprising a non-transitory computer readable medium having computer executable instructions stored thereon, the instructions for configuring one or more processors to perform a method comprising:
receiving electrical signal trace data from a photon-number resolving detector;
determining a predicted photon number associated with the electrical signal trace data by inputting a plurality of trace data points to a machine learning model trained to output predicted photon number data in response to receiving one or more trace data points as input, wherein the plurality of trace data points are defined based on the received electrical signal trace data, and wherein each trace data point is defined to include a trace signal value and a trace data point time value; and
transmitting an output signal based on the determined photon number.

9. The computer program product of claim 8, wherein the instructions are defined to configure the one or more processors to define the output signal in response to determining that the predicted photon number has an associated prediction confidence level above a predefined confidence threshold.

10. The computer program product of claim 8, wherein:
the machine learning model is trained to output at least one point-specific predicted photon number value in response to each trace data point; and
the instructions are defined to configure the one or more processors to determine the predicted photon number based on a plurality of point-specific predicted photon number values corresponding to the plurality of trace data points.

11. The computer program product of claim 10, wherein:
for at least one trace data point, the at least one point-specific predicted photon number value includes a plurality of photon number prediction sets;
each photon number prediction set corresponds to a potential photon number and includes an associated photon number probability for that potential photon number; and
the instructions are defined to configure the one or more processors to determine the predicted photon number as the potential photon number having the highest aggregate probability value across the plurality of trace data points.

12. The computer program product of claim 8, wherein the machine learning model is defined as an autoregressive model to accommodate overlapping electrical signal trace data corresponding to a sequence of optical pulses received by the photon-number resolving detector.

13. The computer program product of claim 8, wherein the instructions are defined to configure the one or more processors to:
define the output signal as a control signal that corresponds to the determined photon number; and
transmit the control signal to a related signal switch, wherein the control signal is defined to cause the related signal switch to switch to a specified routing path to route a related optical pulse in response to the control signal.

14. A system comprising:
one or more processors; and
one or more non-transitory storage mediums having stored thereon a machine learning model trained to output predicted photon number data in response to receiving one or more trace data points as input;
wherein
the one or more processors are configured to:
receive electrical signal trace data from a photon-number resolving detector;
determine a predicted photon number associated with the electrical signal trace data by inputting a plurality of trace data points to the machine learning model, wherein the plurality of trace data points are defined based on the received electrical signal trace data, and wherein each trace data point is defined to include a trace signal value and a trace data point time value; and
transmit an output signal based on the determined photon number.

15. The system of claim 14, wherein the one or more processors is further configured to define the output signal in response to determining that the predicted photon number has an associated prediction confidence level above a predefined confidence threshold.

16. The system of claim 14, wherein:
the machine learning model is trained to output at least one point-specific predicted photon number value in response to each trace data point; and
the one or more processors is configured to determine the predicted photon number based on a plurality of point-specific predicted photon number values corresponding to the plurality of trace data points.

17. The system of claim 16, wherein:
for at least one trace data point, the at least one point-specific predicted photon number value includes a plurality of photon number prediction sets;
each photon number prediction set corresponds to a potential photon number and includes an associated photon number probability for that potential photon number; and
the one or more processors is configured to determine the predicted photon number as the potential photon number having the highest aggregate probability value across the plurality of trace data points.

18. The system of claim 14, wherein the machine learning model is defined as an autoregressive model to accommodate overlapping electrical signal trace data corresponding to a sequence of optical pulses received by the photon-number resolving detector.

19. The system of claim 14, further comprising a photon-number resolving detector, wherein the photon-number resolving detector is operable to:
receive a first optical pulse;
produce the electrical signal trace data in response to the first optical pulse; and
transmit the electrical signal trace data to the one or more processors.

20. The system of claim 14, wherein the one or more processors is configured to:
define the output signal as a control signal that corresponds to the determined photon number; and
transmit the control signal to a related signal switch, wherein the control signal is defined to cause the related signal switch to switch to a specified routing path to route a related optical pulse in response to the control signal.
